(19) United States
(12) Patent Application Publication
(10) Pub. No.: US 2014/0031110 A1
(43) Pub. Date: Jan. 30, 2014

(54) METHOD FOR RANKING AND COMPARING SPORTS LEAGUES

(71) Applicant: Ryan Michael Mercer, Charlotte, NC (US)

(72) Inventor: Ryan Michael Mercer, Charlotte, NC (US)

(21) Appl. No.: 13/938,364

(22) Filed: Jul. 10, 2013

Related U.S. Application Data
(60) Provisional application No. 61/677,084, filed on Jul. 30, 2012.

(51) Int. Cl. A63F 13/12

(52) U.S. Cl. CPC A63F 13/12
USPC 463/29

(57) ABSTRACT

Disclosed is a method of ranking and comparing fantasy sports leagues hosted by different fantasy sports providers using a computer. A computer is provided that is capable of receiving statistical facts from a statistical collector organization, receiving registrations of fantasy sports leagues and teams, and linking the statistical facts with the fantasy sports leagues and teams. The fantasy sports teams and leagues from different providers are then registered with the computer and the computer imports the facts and links the facts to the fantasy teams and leagues. Point totals are calculated by the computer and published for periods of time. As the rosters of fantasy sports teams are changed throughout a fantasy sports season, the point totals are calculated accordingly. At the conclusion of the fantasy sports season, the leagues from the different providers are ranked and compared to each other.

### RELATED APPLICATIONS

This application is a non-provisional application of, claims priority from, and incorporates by reference co-pending, U.S. Provisional Patent Application No. 61/677,084 filed Jul. 30, 2012.

### TECHNICAL FIELD AND BACKGROUND OF THE INVENTION

This application relates to the field of sports and games and more particularly to the field of mock sports and games where actual sports and games events provide data which the mock sports and games utilize. In this field, the data from the actual events is used by human manipulatable personal computers to simulate additional, mock events wherein humans compete in simulated competition.

Presently in the art there exist many different sports and games in which humans interact in competition. The sports include such competitive events as football, baseball, basketball, soccer, hockey, volleyball, golf, horse racing, dog racing, automobile racing, and countless more. Likewise, games might include card games, roulette, chess, checkers, and countless more. In each sport or game, there are often different levels of competition. For instance, levels of competition may include: professional competition, semi-professional competition, collegiate competition, high school competition, amateur competition, Olympic competition, special athlete competition, etc. . . . . In the modern era, it has become common in the field of sports to record the statistical facts from an event of competition. For instance, record keepers may record how many hits a batter achieved in a baseball game, how many blocked shots a defender had in a basketball game, or how many yards a running back garnered in a given football game. Historically, these statistics have been gathered and stored for review by statisticians. More recently, with the advent of the internet and modern computing, the statistics have been published to the world for instant access.

Because the statistics of individual athletes from sports and games are often instantly available, the use of the statistics has progressed beyond mere factual review. Indeed, the statistical facts have become the building block of a new industry dubbed “fantasy sports.” Fantasy sports defines a class of sport or game where simulated teams (“fantasy teams”) and simulated events (“fantasy games”) are created from the factual statistical performance of athletes.

In the fantasy sports industry, several different statistical collector organizations collect and distribute statistics as they are generated on the field of human competition. Several other fantasy providers receive the statistics from the statistical collector organizations and provide an environment where non-athlete humans (“fantasy team owners”) engage in simulated competition (“fantasy games”) based on the statistics received from the statistical collector organizations. It is typical in the art for the statistics to be tied to individual athletes though they may be tied to teams as a whole as well or to sub-groups of teams such as a team defense or a team offense. Fantasy providers employ a system where simulated points (“fantasy points”) are attached to various individual athlete statistics. For instance, if Professional Football Player A ran for ten yards and then scored a touchdown, the fantasy provider might award the player one point for running ten yards and six points for scoring a touchdown. If Professional Football Player A did such a feat two more times in a game, he would be awarded a total of twenty-one fantasy points.

Based on how many fantasy points a player is likely to earn, fantasy team owners will build a “fantasy team” that includes various athletes. The building of the fantasy team is known as a “fantasy draft” and it is often the start of a term of play known as a “fantasy season.” It is common for fantasy teams to be formed in groups called “fantasy leagues.” In a fantasy league, various fantasy teams will periodically compete against one another. Thus, athletes compete and their statistics are translated into fantasy points. In a given competition, a fantasy owner accumulates points as against another fantasy owner. The fantasy team with the most points in the fantasy competition is declared the winner of that particular fantasy game. Each fantasy team plays other fantasy teams from within their particular fantasy league with each contest having a winner and a loser. Fantasy teams in one fantasy league do not play fantasy teams from another league. Typically, the fantasy leagues will include a fantasy playoff that determines the best fantasy team in the particular fantasy league.

Thus, the art currently includes a fantasy sports system which includes multiple different fantasy sports providers. Each of the fantasy sports providers has a multitude of fantasy sports leagues and each league has many fantasy sports teams. Indeed, several of the largest fantasy sports providers each include thousands of fantasy sports leagues with each league having many fantasy teams. Typically one of the fantasy team owners is considered the “fantasy league commissioner” and he or she is charged with maintaining the mechanics of the fantasy league play. In these leagues, a fantasy team owner competes against other fantasy team owners within a single league and thus, at the end of the fantasy season, the members of the fantasy league know which fantasy team was the best team in the fantasy league. However, there is no means of comparing the relative strengths of a fantasy team located in a fantasy league of one fantasy provider with a different fantasy team located in a different fantasy league controlled by another fantasy provider. Likewise, there is no means of comparing the overall strength of one fantasy league maintained by a commissioner and controlled by one fantasy provider with the strength of another fantasy league maintained by a different commissioner and controlled by another fantasy provider. That is, one fantasy league may have three teams who perform well, achieving many fantasy points but it may also have seven teams that perform poorly, and achieve few fantasy points. Conversely, another fantasy league may have seven teams who perform well, achieving many fantasy points but it may also have only three teams that perform poorly, achieving few fantasy points. One fantasy league may be a stronger or tougher fantasy league within which to play than the other. However, there is no measurable way to compare such leagues. Similarly, different fantasy leagues or different fantasy providers may have differing schemes for apportioning points. For instance, one fantasy league may award five points for a touchdown whereas another may award seven. In this way, a fantasy team owner wishing to compare his fantasy team and his fantasy league to the fantasy team and league of another, has no ready means of doing so since the point schemes differ. This scenario is especially true where the various fantasy teams and fantasy leagues are operated in the fantasy environment provided by different fantasy providers. Furthermore, because the different fantasy providers are most often in direct commercial competition with each other, the fantasy providers do not provide any means of connection between the fantasy leagues of the different fantasy providers.

A fantasy sports team owner may brag that he has the best team in the best league but there is no measurable way of confirming such a comparison. Thus, there is a need in the art for a method of comparing the fantasy teams of different leagues and the leagues of different fantasy providers with one another in order to determine which fantasy team or which fantasy league is indeed better.

### SUMMARY OF THE INVENTION

Therefore, it is an object of the invention to provide a method of comparing one team in one league of one fantasy provider with another team in another league of another fantasy provider. It is also an object of the invention to provide a method of comparing one league of one fantasy provider with another league of another fantasy provider. It is a further object of the invention to provide a method that awards a prize to the fantasy league or leagues having the most points at the end of a fantasy sports season.

These and other objects and advantages of the invention are achieved by providing a method of ranking and comparing a plurality of fantasy sports leagues using a computer. The method is practiced by first providing a computer that receives from a statistical collector organization a plurality of statistical facts relating to performance of a plurality of athletes and a plurality of teams. The computer further receives registrations from a plurality of fantasy sports leagues. Each of the leagues has a plurality of fantasy sports teams and each fantasy sports teams include a plurality of fantasy athletes. Each of the fantasy sports teams is controlled by a single fantasy sports team owner. The computer also is capable of linking the fantasy sports athletes and the fantasy sports teams with the plurality of athletes and the plurality of teams, respectively.

A next step of the method includes registering the plurality of fantasy sports leagues with the computer such that at least two of the fantasy sports leagues are maintained by different fantasy sports providers. A next step of the method includes importing to the computer a fantasy team roster of fantasy sports athletes for each of the fantasy sports teams of each of the fantasy sports leagues. A next step includes receiving into the computer the statistical facts pertaining to the athletes performance, covering a specified period of time, from the statistical collector organization and linking each of the fantasy sports athletes with each of the athletes. A next step includes causing the computer to assign a point value to each of the statistical facts from the specified period of time, adding and calculating point totals for each fantasy sports athlete and each fantasy sports team, and adding and calculating point totals for each league. A next step includes causing the computer to import all fantasy team roster changes, relative to a previous specified period of time, from the fantasy sports providers. A next step includes repeating steps of receiving the statistical facts, causing the computer to assign point values to the facts and adding the point totals, and obtaining roster changes. These steps are repeated for successive specified periods of time, until the conclusion of the fantasy sports season. The final step of the method includes causing the computer to add and calculate all points earned during the successive specified periods of time by each fantasy sports league and ranking the plurality of fantasy sports leagues from most points to least points.

According to another embodiment of the invention, a further step is added to the end that includes awarding the fantasy sports team that finishes first with a prize.

According to another embodiment of the invention, an additional step includes causing the computer to publish all of the point totals added in step e covering the specified time period.

According to another embodiment of the invention, the computer is a server that is capable of accessing and being accessed via an internet connection.

According to another embodiment of the invention, a plurality of fantasy sports team owners and a plurality of fantasy sports league commissioners access the server over the internet via a personal internet connection. Further the steps including the registration the importing is performed by the plurality of fantasy sports team owners and fantasy sports league commissioners via their respective personal internet connections.

According to another embodiment of the invention, the statistical facts are received by the server over the internet connection from an internet accessible database maintained by the statistical collector organization.

According to another embodiment of the invention, the fantasy team roster changes are imported by the server over the internet connection from an internet accessible database maintained by the fantasy sports providers.

According to another embodiment of the invention, the point totals are published on the internet by the server.

According to another embodiment of the invention, the personal internet connection may be a personal computer, a telephone, a cellular phone, a digital phone, an internet terminal, a tablet computer, or any other device capable of accessing the internet.

According to another embodiment of the invention, the plurality of fantasy sports team owners and the plurality of fantasy sports league commissioners are required by the server to enter a password into the personal internet connection before accessing the server.

### BRIEF DESCRIPTION OF THE DRAWINGS

The present invention is best understood when the following detailed description of the invention is read with reference to the accompanying drawing, in which:

FIG. 1 is a flow chart of an embodiment of the method of the invention;

FIG. 2 is a block diagram of an embodiment of the network of the method of the invention; and

FIG. 3 is a table and diagram displaying simulated point totals for teams and leagues and respective rankings of fantasy sports leagues.

### DESCRIPTION OF THE PREFERRED EMBODIMENTS AND BEST MODE

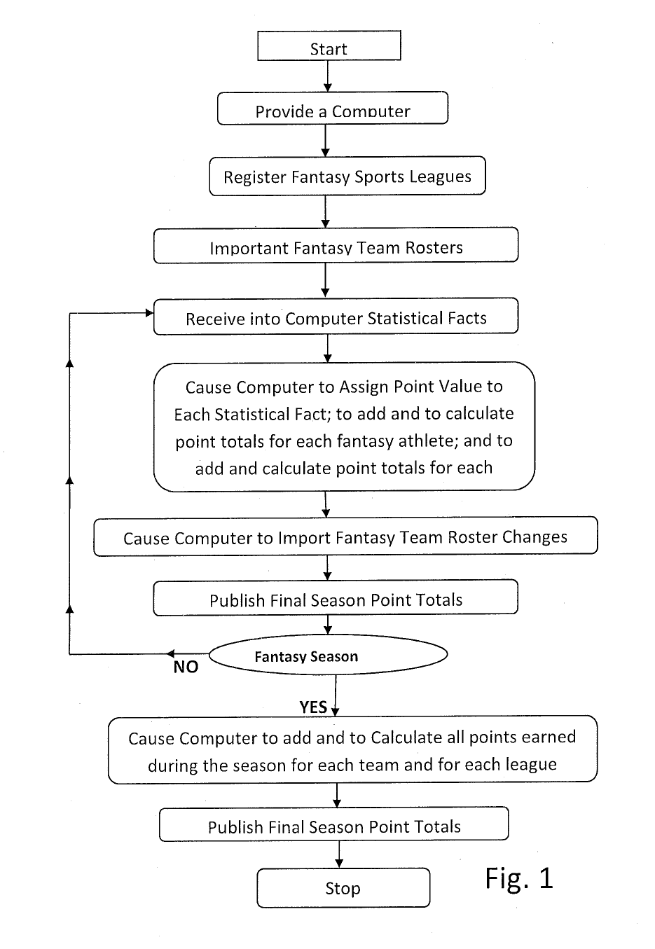

Referring now specifically to the drawings, FIG. 1 shows a flow chart of an embodiment of the invention. It can be seen that the method begins with the provision of a computer. The computer may be a personal computer, server, or other similar device capable of receiving specified input of fantasy team rosters and statistical facts, associating the facts with the fantasy teams, applying a point value to the facts, calculating point totals for each team roster, and ranking the fantasy teams and respective leagues.

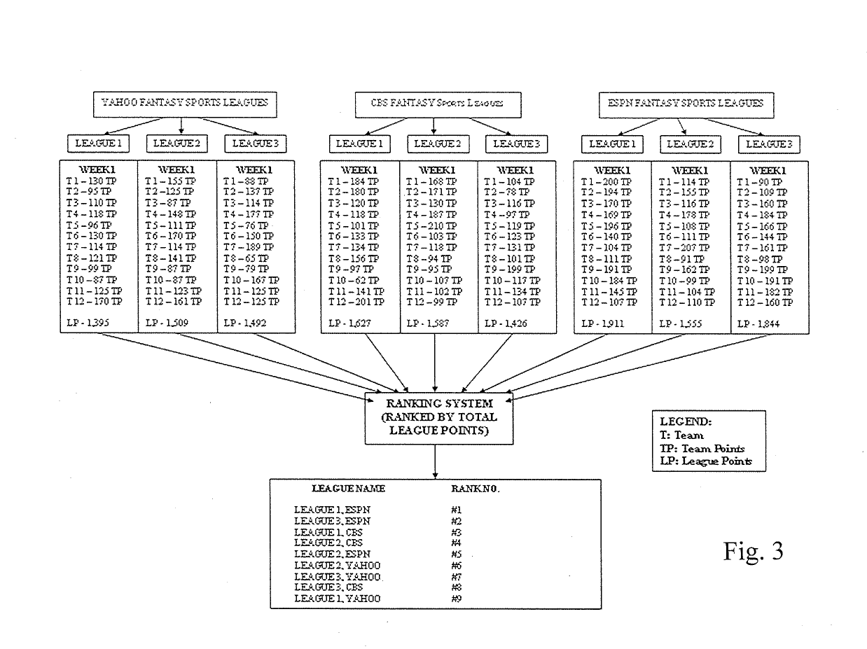

Next the flow chart of FIG. 1 shows that fantasy sports leagues are registered via the computer. The method requires that at least two of the fantasy sport leagues are associated and maintained by different fantasy sports providers. By way of example, FIG. 3 exhibits three different fantasy sports providers, namely, Yahoo, CBS, and ESPN. However, the invention is not limited to these three and the method may involve different fantasy sports providers or more fantasy sports providers or less fantasy sports providers. Each fantasy sports provider hosts a multitude of leagues. For simplicity, FIG. 3 shows each of the fantasy sports providers having three leagues where each fantasy sports league further comprises twelve fantasy sports teams. However, the invention contemplates the fantasy sports providers may each have many more leagues totaling in the tens, hundreds, thousands, or more. Likewise, each of the leagues may have varying numbers of teams. For instance, leagues may have six, eight, ten, twelve, fourteen, or sixteen teams or more or less.

Next, FIG. 1 shows that the fantasy team rosters are imported into the computer. This process is completed for each fantasy sports team of each fantasy sports league associated with each of the fantasy sports providers. In one embodiment, the fantasy sports league commissioners register the entire league and is responsible for importing these initial fantasy sports team rosters. In another embodiment, individual team owners, within a league, may import their team's roster. In another embodiment, the fantasy sports provider may register the rosters of the fantasy teams of a fantasy league. In still another embodiment, it may be the case that fantasy sports team owners authorize the computer, or those maintaining the computer, to import the initial roster fantasy team rosters.

Next, the flow chart displays that statistical facts are received into the computer. Statistical facts relate to the performance of athletes during a specified period of time. Typically, these facts are obtained from a statistical collector organization. The computer links the statistical facts from each of the athletes with each of the fantasy sports athletes that are associated with the fantasy team rosters.

Next, the flow chart displays that the computer assigns point values to each of the statistical facts. The point values may be positive or negative and may be an integer or a fraction. The point values may vary depending on the particulars of the sport. During this step, the computer calculates fantasy sports league totals by adding together fantasy sports team totals. The fantasy sports team totals are calculated by adding together the value of points for each fantasy sports player on each fantasy sports team. These point totals for each team and/or for each league may be published.

Following the conclusion of the specified period of time, fantasy team owners may make changes and alterations to their rosters. If the fantasy team owners make changes to their rosters, these changes are imported to the computer in the next step as displayed in FIG. 1.

The decision box of FIG. 1 asks the question “Fantasy Season Over?” If the season is not over, the new statistical facts are then associated with the roster changes previously imported. The respective team and league points are calculated based on the roster changes and the new statistical facts which occurred following the conclusion of the previous specified period. Likewise, the point totals for this new period may be published.

If, however, the season is over, the computer then calculates an aggregate point totals for each fantasy sports team and for each fantasy sports league. The computer may rank the teams in each fantasy sports league and in each fantasy sports league according to most cumulative points awarded during the pendency of the fantasy sports season. These results may then be published. Though not shown in FIG. 1, a prize or prizes may be award to fantasy sports teams and/or fantasy sports leagues according to their respective point totals.

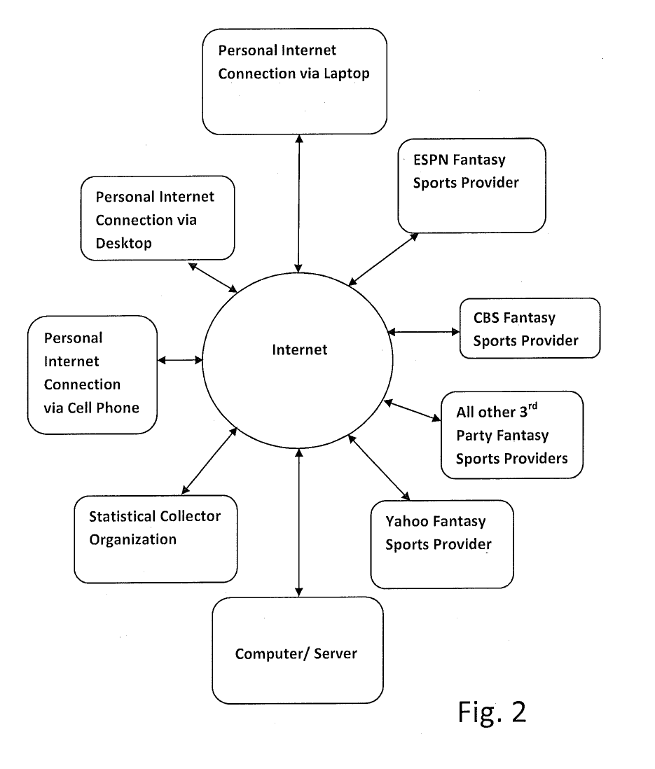

Referring now to FIG. 2, it can be seen that the various modules of the present invention connect to one another via the internet. These various modules utilize the internet in connecting to the computer/server of the present invention. For instance, the computer may receive the statistical facts from the statistical collector organization(s) over the internet. Similarly, the computer may receive the initial rosters over the internet from the team owners who access the computer via a desktop computer or a cell phone. Or, the computer may obtain roster changes over the internet from the fantasy sports providers such as Yahoo, CBS, ESPN, or another fantasy sports provider. The computer may utilize the internet to publish the rankings of the teams and/or the leagues during and/or at the conclusion of a fantasy sports season.

Referring now to FIG. 3, the method contemplates a ranking system where fantasy sports teams and fantasy sports leagues are ranked during consecutive periods, such as weeks, and also at the conclusion of a fantasy sports season. FIG. 3 is an example of a typical ranking after one week (the first specified period of time in this example). The method contemplates a hierarchy system of a plurality of fantasy sports providers. Each of the fantasy sports providers comprises a plurality of fantasy sports leagues. Each of the fantasy sports leagues comprises a plurality of fantasy sports teams. Each of the fantasy sports teams comprises a plurality of fantasy sports players which are linked to real life athletes who perform each week (or some other specified period of time) during a sport season. As the athletes perform, their performance is relayed as statistical facts and the computer assigns points to each statistical fact, each fantasy sports team thus accruing fantasy points during each week. For instance, according to the example of FIG. 3, during week 1, team 1 of league 1 of the Yahoo fantasy sports league provider totaled 130 team points. Team 2 of league 1 of the Yahoo fantasy sports league provider totaled 95 team points. In the aggregate for week 1, League 1 of the Yahoo fantasy sports league provider totaled 1,395 team points. In this way, these points are totaled for each team and for each league. The example provided in FIG. 3 shows that League 1 from the ESPN fantasy sports provider finished in first place for Week 1. League 3 from the ESPN fantasy sports provider finished in second place for Week 1. League 1 from the CBS fantasy sports provider finished in third place for Week 1 etc. . . . . These totals and the respective rankings are published. As shown in FIG. 1, this process is carried out each week (or other specified period of time) by the computer throughout the pendency of the fantasy sports season. At the conclusion of the season, a final ranking is determined by aggregating the weekly point totals for each of the fantasy sports teams and also for each of the fantasy sports leagues. The final rankings may likewise published by the computer.

A method for ranking and comparing sports leagues is described above. Various details of the invention may be changed without departing from the scope of the invention. Furthermore, the foregoing description of the preferred embodiment of the invention and best mode for practicing the invention are provided for the purpose of illustration only and not for the purpose of limitation.

I claim:

1. A method of ranking and comparing a plurality of fantasy sports leagues using a computer, comprising the steps of:
a. providing a computer that
i. receives from a statistical collector organization a plurality of statistical facts relating to performance of a plurality of athletes and a plurality of teams,
ii. receives registrations from a plurality of fantasy sports leagues, each league comprising a plurality of fantasy sports teams wherein each fantasy sports teams includes a plurality of fantasy athletes and is controlled by a single fantasy sports team owner, and
iii. links the fantasy sports athletes and the fantasy sports teams with the plurality of athletes and the plurality of teams, respectively;
b. registering the plurality of fantasy sports leagues with the computer wherein at least two of the fantasy sports leagues are maintained by different fantasy sports providers;
c. importing to the computer a fantasy team roster of fantasy sports athletes for each of the fantasy sports teams of each of the fantasy sports leagues;
d. receiving into the computer the statistical facts pertaining to the athletes' performance, covering a specified period of time, from the statistical collector organization and linking each of the fantasy sports athletes with each of the athletes;
e. causing the computer to assign a point value to each of the statistical facts from the specified period of time, adding and calculating point totals for each fantasy sports athlete and each fantasy sports team, and adding and calculating point totals for each league;
f. causing the computer to import all fantasy team roster changes, relative to a previous specified period of time, from the fantasy sports providers;
g. repeating steps d, e, and f, for successive specified periods of time, until the conclusion of the fantasy sports season; and
h. causing the computer to add and calculate all points earned during the successive specified periods of time by each fantasy sports league and ranking the plurality of fantasy sports leagues from most points to least points.

2. The method of comparing a plurality of fantasy sports leagues using a computer of claim 1 wherein an additional step i is added to the end that comprises the step of: awarding the fantasy sports team that finishes first with a prize.

3. The method of claim 1 wherein an additional step is inserted between step e and step f wherein the step comprises causing the computer to publish all of the point totals added in step e covering the specified time period.

4. The method of claim 1 wherein the computer provided in step a is a server that is capable of accessing and being accessed via an internet connection.

5. The method of claim 4 wherein a plurality of fantasy sports team owners and a plurality of fantasy sports league commissioners access the server over the internet via a personal internet connection and wherein the registration of step b and the importing of step c is performed by the plurality of fantasy sports team owners and fantasy sports league commissioners via the respective personal internet connections.

6. The method of claim 5 wherein the statistical facts received in step d are received by the server over the internet connection from an internet accessible database maintained by the statistical collector organization.

7. The method of claim 6 wherein the fantasy team roster changes are imported by the server over the internet connection from an internet accessible database maintained by the fantasy sports providers.

8. The method of claim 3 wherein the point totals published are published on the internet by the server.

9. The method of claim 5 wherein the personal internet connection may be selected from the group consisting of: a personal computer, a telephone, a cellular phone, a digital phone, an internet terminal or a tablet computer.

10. The method of claim 9 wherein the plurality of fantasy sports team owners and the plurality of fantasy sports league commissioners are required by the server to enter a password into the personal internet connection before accessing the server.

11. A method of ranking and comparing a plurality of fantasy sports leagues using a computer, comprising the steps of:
a. providing a computer that
i. receives from a statistical collector organization a plurality of statistical facts relating to performance of a plurality of athletes and a plurality of teams,
ii. receives registrations from a plurality of fantasy sports leagues, each league comprising a plurality of fantasy sports teams wherein each fantasy sports teams includes a plurality of fantasy athletes and is controlled by a single fantasy sports team owner, and
iii. links the fantasy sports athletes and the fantasy sports teams with the plurality of athletes and the plurality of teams, respectively;
b. registering the plurality of fantasy sports leagues with the computer wherein at least two of the fantasy sports leagues are maintained by different fantasy sports providers;
c. importing to the computer a fantasy team roster of fantasy sports athletes for each of the fantasy sports teams of each of the fantasy sports leagues;
d. receiving into the computer the statistical facts pertaining to the athletes' performance, covering a specified period of time, from the statistical collector organization and linking each of the fantasy sports athletes with each of the athletes;
e. causing the computer to assign a point value to each of the statistical facts from the specified period of time, adding and calculating point totals for each fantasy sports athlete and each fantasy sports team, and adding and calculating point totals for each league;
f. publishing all of the point totals added in step e covering the specified period of time;
g. causing the computer to import all fantasy team roster changes, relative to a previous specified period of time, from the fantasy sports providers;
h. repeating steps d, e, f, and g for successive specified periods of time, until the conclusion of the fantasy sports season;
i. causing the computer to add and calculate all points earned during the successive specified periods of time by each fantasy sports league and ranking the plurality of fantasy sports leagues from most points to least points; and
j. awarding the fantasy sports team that finishes first with a prize.

12. The method of claim 11 wherein the computer provided in step a is a server that is capable of accessing and being accessed via an internet connection.

13. The method of claim 12 wherein a plurality of fantasy sports team owners and a plurality of fantasy sports league commissioners access the server over the internet via a personal internet connection and wherein the registration of step b and the importing of step c is performed by the plurality of fantasy sports team owners and fantasy sports league commissioners via the respective personal internet connections.

14. The method of claim 13 wherein the statistical facts received in step d are received by the server over the internet connection from an internet accessible database maintained by the statistical collector organization.

15. The method of claim 14 wherein the fantasy team roster changes are imported by the server over the internet connection from an internet accessible database maintained by the fantasy sports providers.

16. The method of claim 11 wherein the point totals published are published on the internet by the server.

17. The method of claim 13 wherein the personal internet connection may be selected from the group consisting of: a personal computer, a telephone, a cellular phone, a digital phone, an internet terminal or a tablet computer.

18. The method of claim 17 wherein the plurality of fantasy sports team owners and the plurality of fantasy sports league commissioners are required by the server to enter a password into the personal internet connection before accessing the server.
